(19) United States
(12) Patent Application Publication
(10) Pub. No.: US 2018/0174538 A1
(43) Pub. Date: Jun. 21, 2018

(54) DISPLAY APPARATUS AND DRIVING METHOD THEREOF

(71) Applicant: SAMSUNG ELECTRONICS CO., LTD., Suwon-si (KR)

(72) Inventors: Kyu-heon LEE, Hwaseong-si (KR); Hyun-chul SONG, Suwon-si (KR)

(21) Appl. No.: 15/667,919

(22) Filed: Aug. 3, 2017

(30) Foreign Application Priority Data
Dec. 20, 2016 (KR) 10-2016-0174873

(51) Int. Cl. G09G 3/36; G02F 1/1335

(52) U.S. Cl. CPC G09G 3/3648; G02F 1/133602; G09G 2320/0626; G09G 2320/0673; G09G 3/3607

(57) ABSTRACT

A display apparatus is provided, the display apparatus includes a display panel, a backlight unit comprising a light source which irradiates a light to the display panel, a storage which stores a gamma curve indicating relationship between a gray level of an input signal and a luminance of an output signal, and a processor configured to control the backlight unit to decrease a brightness of the light provided to the display panel based on a difference between a first output luminance value which is a maximum luminance value of the display panel and a second output luminance value of the input signal, in which the second output luminance value may be an output luminance value corresponding to the maximum gray level value of the input signal in the gamma curve.

### CROSS-REFERENCE TO RELATED APPLICATION

This application is based on and claims priority under 35 U.S.C. § 119 to Korean Patent Application No. 10-2016-0174873, filed on Dec. 20, 2016 in the Korean Intellectual Property Office, the disclosure of which is incorporated by reference herein in its entirety.

### BACKGROUND

### 1. Field

The present disclosure relates generally to a display apparatus and a driving method thereof, and for example, to a display apparatus having a backlight and a driving method thereof.

### 2. Description of Related Art

Liquid crystal display refers to a display apparatus includes a liquid crystal layer having an anisotropic dielectric constant on upper and lower transparent insulating substrates, and expresses a desired image by adjusting a intensity of electric field formed on the liquid crystal layer to change the molecular arrangement of the liquid crystal material, and accordingly controlling the amount of light passed therethrough to the transparent insulating substrates.

As a liquid crystal display, a thin film transistor liquid crystal display apparatus (TFT LCD) using a thin film transistor (TFT) as a switching element is mainly used, and such liquid crystal display apparatus includes a liquid crystal panel comprising pixels divided into arrays of gate lines and data lines intersecting each other to display an image, a driver for driving the liquid crystal panel, a backlight unit for supplying light to the liquid crystal panel, and a color filter for transmitting light supplied to the liquid crystal panel.

Meanwhile, the power consumption by the light sources of the backlight unit and the inverter circuit for driving the light sources takes up almost a half the total power consumption of the liquid crystal display apparatus. Therefore, in order to reduce the power consumption of the liquid crystal display apparatus, an effective method is to decrease the power consumption of the backlight unit. As a method for reducing the power consumption of the backlight unit, the backlight dimming method is most widely used.

However, global backlight dimming that lowers the overall backlight luminance of the entire screen has a problem of causing distortion of the gamma curve applied to the liquid crystal display apparatus.

### SUMMARY

Example embodiments of the present disclosure address the above disadvantages and other disadvantages not described above.

In order to address the problems described above, example embodiments provide a display apparatus and a driving method thereof capable of global dimming driving a backlight while maintaining a gamma curve.

According to an example aspect of the present disclosure for achieving the aforementioned purposes, a backlight unit comprising a light source configured to provide a light to the display panel, a backlight driver comprising circuitry configured to drive the backlight unit, a storage which stores a gamma curve corresponding to a relationship between a gray level of an input signal and a luminance of an output signal, and a processor configured to control the backlight unit to decrease a brightness of the light provided to the display panel based on a difference between a first output luminance value which is a maximum luminance value of the display panel and a second output luminance value of the input signal, in which the second output luminance value may be an output luminance value corresponding to the maximum gray level value of the input signal in the gamma curve.

Further, the first luminance value may be an output luminance value corresponding to a maximum gray level value that can be output by the display panel.

Further, the processor may collectively decrease the brightness of a plurality of light sources comprising the backlight unit based on the difference between the first output luminance value and the second output luminance value.

Further, the processor may decrease at least one of current duty and current intensity of the backlight unit based on the difference between the first output luminance value and the second output luminance value.

Further, if at least one of a target current duty and a target current intensity of the backlight unit is determined based on the difference between the first output luminance value and the second output luminance value, the processor may stepwise decrease at least one of the current duty and the current intensity of the backlight unit to at least one of the target current duty and the target current intensity.

Further, if at least one of a current duty variation and a current intensity variation of the backlight unit is determined based on the difference between the first output luminance value and the second output luminance value, the processor may stepwise decrease at least one of the current duty and the current intensity of the backlight unit.

Further, the processor may calculate (determine) the first output luminance value corresponding to a maximum gray level value in units of at least one frame of the input signal and decreases the brightness of the light provided to the display panel in units of at least one frame.

Further, the processor may compensate for luminance drop due to a decrease in the brightness of the backlight unit, with a gray level value of the input signal.

Further, the processor may calculate (determine) a gain value for compensating for the luminance drop based on the maximum gray level value of the input signal and apply the gain value to the gray level value of the input signal to calculate a compensated gray level value.

Further, the display panel may be implemented as a liquid crystal panel.

Meanwhile, according to an example embodiment of the present disclosure, a driving method of a display apparatus in which a gamma curve corresponding to a relationship between a gray level of an input signal and a luminance of an output signal is stored, is provided in which the driving method may include receiving an input signal, and decreasing a brightness of the light provided to the display panel based on a difference between a first output luminance value which is a maximum luminance value of the display panel and a second output luminance value of the input signal. In an example, the second output luminance value may be an output luminance value corresponding to the maximum gray level value of the input signal in the gamma curve.

Further, the first luminance value may be an output luminance value corresponding to a maximum gray level value that can be output by the display panel.

Further, the decreasing the brightness of the light may include collectively decreasing the brightness of a plurality of light sources comprising the backlight unit that provides a light to the display panel, based on the difference between the first output luminance value and the second output luminance value.

Further, the decreasing the brightness of the light may include decreasing at least one of current duty and current intensity of the backlight unit based on the difference between the first output luminance value and the second output luminance value.

Further, if at least one of a target current duty and a target current intensity of the backlight unit is determined based on the difference between the first output luminance value and the second output luminance value, the decreasing the brightness of the light comprise may include stepwise decreasing at least one of the current duty and the current intensity of the backlight unit to at least one of the target current duty and the target current intensity.

Further, if at least one of a current duty variation and a current intensity variation of the backlight unit is determined based on the difference between the first output luminance value and the second output luminance value, the decreasing the brightness of the light may include stepwise decreasing at least one of the current duty and the current intensity of the backlight unit.

Further, the decreasing the brightness of the light may include calculating the first output luminance value corresponding to a maximum gray level value in units of at least one frame of the input signal and decreases the brightness of the light provided to the display panel in units of at least one frame.

Further, the driving method may additionally include compensating for luminance drop due to a decrease in the brightness of the backlight unit, with a gray level value of the input signal.

Further, the compensating may include calculating (determining) a gain value for compensating for the luminance drop based on the maximum gray level value of the input signal and apply the gain value to the gray level value of the input signal to calculate a compensated gray level value.

In an example, the display panel may be implemented as a liquid crystal panel.

As described above, according to various example embodiments of the present disclosure, the backlight can be controlled with global dimming while the gamma curve is maintained, so that the gray level of the input signal can be accurately expressed. Further, the black signal may be improved so that the contrast ratio may be improved

### BRIEF DESCRIPTION OF THE DRAWINGS

The above and/or other aspects, features and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example global dimming method according to an example embodiment of the present disclosure;

FIG. 2A is a block diagram illustrating an example configuration of a display apparatus according to an example embodiment of the present disclosure;

FIG. 2B is a diagram illustrating an example configuration of a display apparatus according to an example embodiment of the present disclosure;

FIG. 3 is a diagram illustrating an example method of expressing pixel values of an LCD panel according to an example embodiment of the present disclosure;

FIG. 4 is a diagram illustrating an example gamma curve according to an example embodiment of the present disclosure;

FIGS. 5 and 6 are diagrams illustrating an example PWM dimming method according to an example embodiment of the present disclosure;

FIGS. 7A, 7B, and 8 are diagrams illustrating an analog dimming method according to an example embodiment of the present disclosure; and

FIG. 9 is a flowchart illustrating an example method of driving a display apparatus according to an example embodiment of the present disclosure.

### DETAILED DESCRIPTION

The terms used in this disclosure will be briefly described prior to describing the present disclosure in detail.

In explaining example embodiments, a “module” or “unit” may perform at least one function or operation and may be implemented as hardware or software, or as a combination of hardware and software. Further, a plurality of “modules” or “units” may be integrated into at least one module to be implemented by at least one processor (not illustrated), except for if it is necessary that the “modules” or “units” are implemented as specific hardware.

Hereinafter, various example embodiments of the present disclosure will be described in greater detail with reference to the accompanying drawings. However, the present disclosure may be embodied in many different forms and is not limited to the example embodiments described herein. In the following description, functions or elements that may not be relevant to the present disclosure may not be described for the sake of clarity, and like reference numerals are used for referring to the same or similar elements in the description and drawings.

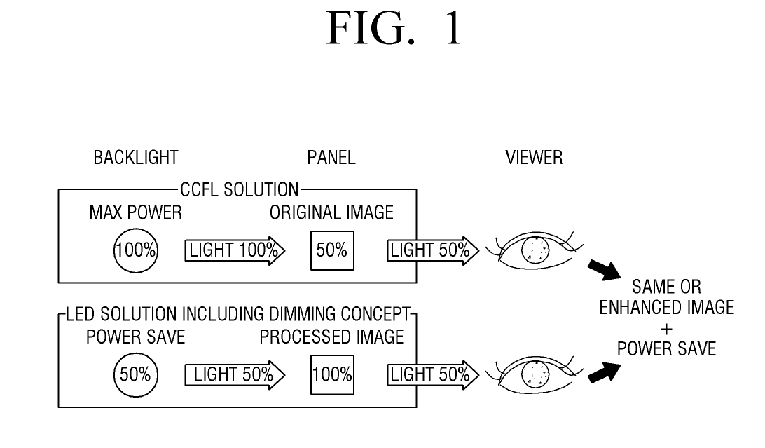

FIG. 1 is a diagram illustrating an example backlight dimming method according to an example embodiment of the present disclosure.

A display panel such as an LCD panel formed by an element that does not emit light by itself needs a backlight in a display module in order to realize an image. For example, upon activating of the backlight, a 46-inch, CCFL-based LCD TV consumes total 240 watts. Even if backlight activation is not absolutely necessary, such as for a dark scene, it is always 100% running, and as power increases, the backlight and display module temperatures also increase. This may affect LCD characteristics due to excessive thermal gradients of the heat emitted by the backlight. For this reason, the brightness of the backlight, that is, power consumption is limited as much as possible.

As a method for reducing the power consumption of a backlight, a backlight dimming method is widely used. The backlight dimming method may be divided into local dimming in which the screen is divided into a plurality of blocks and backlight luminance is individually controlled for each block, and global dimming in which the backlight luminance of the entire screen is lowered collectively. The local dimming may improve the static contrast by locally controlling the luminance of the screen in one frame period, and reduce the power consumption. The local dimming has a disadvantage that it requires complicated algorithms and hardware configuration, and may be applied only to a direct-type light emitting diode (LED) backlight unit which allows easy luminance control for each block. The global dimming may improve dynamic contrast and lower power consumption. The global dimming does not require complicated algorithms and hardware configuration and may be applied to any type of backlight unit.

Meanwhile, a display is generally set such that the luminance is output based on the gamma curve according to the relationship between the gray level (brightness) of the input signal and the output luminance. The term “luminance” as used herein may refer, for example, to a light density in a specific direction, that is, an amount of light that passes through a certain area and enters at a certain solid angle, which is expressed on the basis of a unit by candela (Cd/m2) or nit per area. A gamma curve (or a gamma graph or a gamma table) represents an incoming gray level (this is mainly 8 bits and may be represented as 256 gray levels) on the X axis, an outgoing luminance (%) on the Y axis, and the gamma value with a slope. The human eye is good at distinguishing a difference in the brightness if in the dark place, but it may not distinguish a difference in the brightness if the brightness is above a certain level. Accordingly, if the gamma value is set as 1 in a direct proportion, brighter colors toward the higher gray will not be distinguished very well, and thus, efficiency deteriorates. Accordingly, the gamma value is set to an optimum value for the human eye and this may be 2.2, e.g., the standard gamma value by the National Television System Committee (NTSC).

However, if global dimming is used for a display that is set to be output based on such fixed gamma value, distortion may occur in the gamma curve. Hereinafter, various example embodiments of the present disclosure, in which the gamma curve may be maintained while global dimming of the backlight, will be described in greater detail.

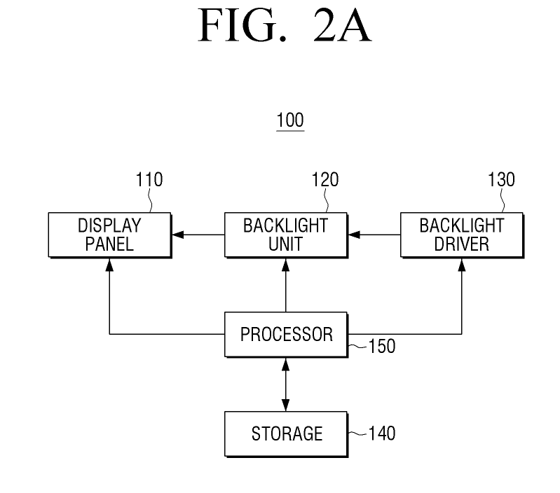

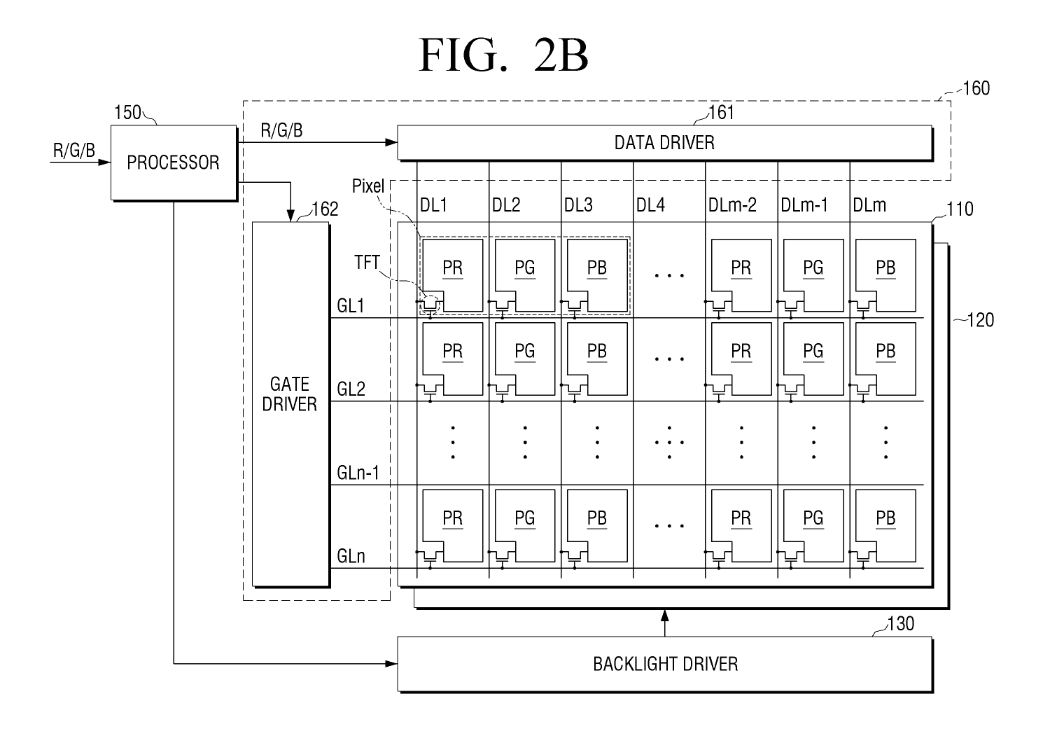

FIG. 2A is a block diagram illustrating an example configuration of a display apparatus according to an example embodiment of the present disclosure.

Referring to FIG. 2, a display apparatus 100 includes a display panel 110, a backlight unit (e.g., including a light source) 120, a backlight driver (e.g., including driving circuitry) 130, a storage 140, and a processor (e.g., including processing circuitry) 150.

The display panel 110 is configured such that a plurality of pixels form one frame, and each pixel may be comprise a plurality of sub-pixels. For example, each pixel may be comprise three sub-pixels corresponding to a plurality of lights including, for example, red, green, and blue lights (R, G, B). However, the present disclosure is not limited thereto, and in some cases, cyan, magenta, yellow, black, or other sub-pixels may be included in addition to red, green, and blue sub-pixels. In this example, the display panel 110 may be implemented as a liquid crystal panel. However, if the backlight dimming according to an example embodiment of the present disclosure is applicable, the display panel may be implemented as a different type of display panel.

The backlight unit 120 may include various light sources and provides a light to the display panel 110.

In particular, the backlight unit 120 provides the light onto a rear surface of the display panel 110, that is, onto a side opposite the surface on which the image is displayed.

The backlight unit 120 may include a plurality of light sources, and the plurality of light sources may include a linear light source such as a lamp or a point light source such as a light emitting diode, although not limited thereto. The backlight unit 120 may be implemented as a direct type backlight unit or an edge type backlight unit. The light source of the backlight unit 120 may include any one, or two or more of a light emitting diode (LED), a hot cathode fluorescent lamp (HCFL), a cold cathode fluorescent lamp (CCFL), and an external electrode fluorescent lamp (EEFL).

The processor 150 drives the backlight unit 120. In this case, the processor 150 may be implemented to include an analog driver IC or a digital driver IC for panel driving. In particular, if the processor 150 is implemented as a DSP, the processor 150 may be implemented in the form of one chip with a digital driver IC.

However, for convenience of description, hereinafter, it is assumed that the backlight driver 130 is implemented separately from the processor 150.

The backlight driver 130 may include various driving circuitry that adjusts the supply time or intensity of the driving current being supplied to the backlight unit 120 according to a value input from the processor 150 and outputs the adjusted driving current.

Specifically, the backlight driver 130 may include various circuitry to control the luminance of the light sources of the backlight unit 120 or vary the intensity of the current, using pulse width modulation (PWM) in which the duty ratio is varied. In this example, the pulse width modulation signal PWM controls the ratio of lighting on and lighting off of the light sources, and the duty ratio (%) thereof is determined according to the dimming value input from the processor 150.

In this case, the backlight driver 130 may include a plurality of light sources comprising the backlight unit 120, such as, for example, at least one LED driver for controlling a current applied to the plurality of LED elements. According to an example embodiment, the LED driver may be disposed in back of a power supply (e.g., Switching Mode Power Supply (SMPS)) to receive voltage from the power supply. However, according to another embodiment, a voltage may be applied from a separate power supply device. Alternatively, it is possible that the SMPS and the LED driver are implemented as a form of a single integrated module.

The storage 140 stores various data necessary for the operation of the display apparatus 100.

For example, the storage 140 stores a gamma curve corresponding to the relationship between the gray level of the input signal (or the input image signal) input to the display panel 110 and the luminance of the output signal. In this example, the gamma curve may be a gamma curve having a gamma value of 2.2 as described with reference to FIG. 1. However, embodiments are not limited hereto, and accordingly, the gamma value may be changed based on the characteristics of the display panel 110 or the output mode of the display apparatus 100 (e.g., movie mode, standard mode, etc.).

The storage 140 may be implemented as an internal memory such as a ROM or a RAM included in the processor 150 or may be implemented as a separate memory from the processor 150. In this case, the storage 140 may be implemented as a memory embedded in the display apparatus 100 or a memory removably attachable to the display apparatus 100 depending on a purpose of storing data in the storage 140. For example, data for driving the display apparatus 100 may be stored in a memory embedded in the display apparatus 100, and data for an extended function of the display apparatus 100 may be stored in a memory that is removably attachable to the display apparatus 100. The memory embedded in the display apparatus 100 may be implemented as a nonvolatile memory, a volatile memory, a hard disk drive (HDD), or a solid state drive (SSD), and the memory removably attachable to the display apparatus 100 may be implemented in a form such as a memory card (e.g., micro SD card, USB memory, etc.), or an external memory (e.g., USB memory) that may be connected to the USB port, and the like.

Meanwhile, according to another example embodiment, the above-described information (e.g., gamma curve or gamma value) stored in the storage 140 may also be acquired from an external device instead of being stored in the storage 140. For example, some information may be received in real time from an external device such as a set-top box, an external server, a user terminal, or the like.

The processor 150 may include various processing circuitry and controls the overall operation of the display apparatus 100. The processor 150 may include various processing circuitry, such as, for example, and without limitation, one or more of a dedicated processor, a central processing unit (CPU), a controller, an application processor (AP), a communication processor (CP), an ARM processor, or may be defined by a corresponding term. Further, the processor 150 may be implemented as a digital signal processor (DSP), a SoC with a content processing algorithm embedded therein, or as a form of a field programmable gate array (FPGA).

The processor 150 may control the backlight driver 130 to control the backlight unit 120 with global dimming based on the gamma curve described above.

In this case, the processor 150 may control the backlight driver 130 based on a first output luminance value of the display panel 110 and a second output luminance value of the input signal.

In this example, the first output luminance value may be an output luminance value corresponding to the maximum gray level value that can be output by the display panel 110. For example, if the display panel 110 outputs an 8-bit image and the maximum luminance that can be output is 500 nit, if the display apparatus 100 is set to output 500 nit for the gray level 255, which is the maximum gray level of an 8-bit image, the first output luminance value may be 500 nit. However, if it is set to output 400 nit that is 20% lower for the maximum gray level of the 8-bit image (e.g., gray level 255), the first output luminance value may be 400 nit. The second output luminance value may be a luminance value corresponding to the maximum gray level value of the input signal.

Specifically, the processor 150 may acquire the first output luminance value based on the number of bits of the image that can be output by the display panel 110, and acquire the second output luminance value corresponding to the maximum gray level of the input signal based on the gamma curve described above. In this example, the first output luminance value may be a maximum gray level value according to an image that can be output by the display panel 110 (for example, 1023 for a 10-bit image, 255 for an 8-bit image). Further, the first output luminance value may be an output luminance value corresponding to pixel data (or sub-pixel data) having the maximum gray level value among the pixel data included in the image frame.

The processor 150 may then control the backlight driver 130 to adjust the brightness of the light provided to the display panel 110 based on a difference between the first output luminance value and the second output luminance value. That is, the processor 150 may control PWM dimming (current duty adjustment) or analog dimming (current intensity (or voltage intensity) adjustment) based on the first output luminance value and the second output luminance value.

Accordingly, the backlight dimming according to an example embodiment of the present disclosure may decrease the brightness of the backlight so that the gamma curve is maintained, thereby preventing and/or reducing the distortion of the input signal as much as possible. The processor 150 may decrease the brightness of the backlight unit 120 by a difference between the first output luminance value and the second output luminance value. In this case, the processor 150 may decrease at least one of the current duty and the current intensity of the backlight unit 120 based on the difference between the first output luminance value and the second output luminance value. For example, based on the current duty 100% (maximum brightness), the current duty may be decreased based on the difference between the first output luminance value and the second output luminance value.

According to an example embodiment, the processor 150 may determine at least one of the target current duty and the target current intensity of the backlight unit 120 based on the difference between the first output luminance value and the second output luminance value.

Meanwhile, if at least one of the target current duty and the target driving current intensity of the backlight unit 120 is determined, the processor 150 may use an infinite impulse response (IIR) filter to prevent and/or reduce occurrence of a transient.

Specifically, if at least one of the target current duty and the driving current intensity of the backlight unit 120 is determined, the processor 150 may stepwise decrease at least one of the current duty and the current intensity of the backlight unit 120 to at least one of the target current duty and the target current intensity.

For example, if the target current duty is determined, the processor 150 may sequentially decrease the current current duty of the backlight unit 120 to the target current duty over a plurality of time units or a plurality of image frame periods.

In this case, if at least one of the target current duty and the target drive current intensity of the backlight unit 120 is determined, the processor 150 may stepwise change the current duty or current intensity based on an amount of the current duty or current intensity that has to be changed to reach at least one of the target current duty and the target drive current intensity.

For example, if the unit of changing the current duty or current intensity is 1% and the total amount of change is 50%, the current duty or current intensity may be changed over a total of 50 steps. For example, if 50% duty change is necessary, the current duty may be changed over a total of 50 steps, by 1% each in 16.6 ms increments. Further, if a 1 V change in voltage is required, the current duty may be changed over a total of 50 steps, by 0.02 V in 16.6 ms increments. In this case, the unit of change may be determined based on the performance of the display apparatus 100. For example, the unit of change may be determined according to the bit range of the register that may be controlled by the main CPU.

According to another example embodiment, the processor 150 may determine at least one of the current duty change amount and the current intensity change amount of the backlight unit 120 based on the difference between the first output luminance value and the second output luminance value. In this case, the processor 150 may stepwise control PWM dimming or analog dimming as described above based on the current duty change amount or the current intensity change amount.

Further, the processor 150 may compensate for the luminance drop due to dimming control of the backlight unit 120, using the gray level value of the input signal. That is, the processor 150 may perform image processing to compensate with the gray level value of the pixel data of the image signal, in order to compensate for the luminance drop due to the global dimming of the backlight unit 120.

In this case, the processor 150 may calculate (determine) a gain value for compensating for the luminance drop based on the maximum gray level value of the input signal, and may calculate (determine) a compensated gray level value by applying the gain value to the gray level value of the input signal.

Specifically, the processor 150 may adjust the gray level of the pixel data upward to compensate for the luminance drop of the backlight luminance.

For example, the processor 150 may set a gain value for gray level compensation based on pixel data having the maximum gray level value in the input frame. This is because there is a limit to the gray level compensation of the pixel data. For example, in the case of 10-bit pixel data, the maximum gray level of the pixel data is 1023, so that an adjustment may not exceed 1023.

For example, if the maximum gray level value of the input frame is 512 with reference to a 10-bit image, the corresponding pixel data may be compensated up to 1023, so that the gain value may be set to 1023/512=1.99 2. In this case, since the remaining pixels have gray level values lower than 512, they do not exceed the maximum gray level even after multiplication by the gain value 2.

However, while the processor 150 may decrease the backlight brightness according to the gamma curve, if the processor 150 cannot express the gray level due to the saturation of the maximum gray level of the pixel data, the processor 150 may adjust the brightness of the backlight upward within a predetermined threshold range. For example, according to the Just Noticeable Difference (JND) theory, the brightness of the backlight may be adjusted upward within a range that is recognized by a user to be the brightness value equal to the backlight brightness determined according to the gamma curve.

Alternatively, the processor 150 may determine a minimum brightness of the backlight by having a clipped rate, which is the ratio of the clipped pixel data to the total number of pixel data of the input image, as a fixed specific value. In this example, the clipped pixel data refer to pixel data exceeding the expressible range of brightness due to the luminance drop of the backlight luminance and the limitation of the maximum gray level value. The clipped rate is a percentage value that is the number of clipped pixels divided by the total number of pixels in the input image. After determining the clipped rate, an RGB histogram for the input image is generated to determine a final clipped point, which is the gray level to be clipped in the corresponding image. The pixel data exceeding the final clipped point are the clipped pixel data. In this case, the minimum brightness of the backlight may be determined by fixing the clipped point to a specific value.

That is, the processor 150 may decrease the backlight brightness according to the gamma curve, but also maintain the minimum brightness of the backlight brightness.

Alternatively, in an input image having a low pixel data distribution with high brightness, the clipped point for determining the minimum brightness of the backlight luminance may be increased. This is because, if the clipped point is fixed to a small value, the image quality may deteriorate considerably in an input image with a low brightness pixel data distribution. Further, in an input image having a low pixel data distribution with high brightness, the clipped point for determining the minimum brightness of the backlight luminance may be increased.

FIG. 2B is a block diagram illustrating an example configuration of the display apparatus illustrated in FIG. 2A. The detailed description of the configurations illustrated in FIG. 2B that are the same as those shown in FIG. 2A may not be repeated here.

The display panel 110 has the gate lines (GL1 to GLn) and the data lines (DL1 to DLm) intersecting with each other, and R, G and B sub-pixels (PR, PG, PB) formed in a region provided by such intersection. The adjacent R, G and B sub-pixels PR, PG and PB form one pixel. That is, each pixel includes an R sub-pixel (PR) representing red (R), a G sub-pixel (PG) representing green (G), and a B sub-pixel (PB) representing blue (B), and reproduces a color of an object in three primary colors of red (R), green (G), and blue (B).

If the display panel 110 is implemented as an LCD panel, each of the sub-pixels (PR, PG, PB) includes a pixel electrode and a common electrode, such that light transmittance is changed as the alignment of the electric field liquid crystal is changed by the electric field formed by the potential difference between the two electrodes is changed. In response to scan pulses from the gate lines (GL1 to GLn), the TFTs formed at the intersections of the gate lines (GL1 to GLn) and the data lines (DL1 to DLm) supply the video data, that is, red (R), green (G) and blue (B) data from the data lines (DL1 to DLm) to the pixel electrodes of the respective sub-pixels (PR, PG, PB), respectively.

A panel driver 160 may include a data driver 161 for supplying video data to the data lines and a gate driver 162 for supplying a scan pulse to the gate lines.

The data driver 161 is provided as a means (e.g., circuitry) for generating a data signal and it receives image data of the R/G/B component from the processor 140 (or from a timing controller (not shown)) and generates a data signal. Further, the data driver 161 is connected to the data lines (DL1, DL2, DL3, . . . , DLm) of the display panel 110 and applies the generated data signals to the display panel 110.

The gate driver 162 (or a scan driver) is provided as a means (e.g., circuitry) for generating a gate signal (or scan signal), and it is connected to the gate lines (GL1, GL2, GL3, GLn) and delivers the gate signal to a particular row of the display panel 110. The data signal output from the data driver 161 is transmitted to the pixel to which the gate signal is transmitted.

The panel driver 160 may also include a timing controller (not shown). The timing controller (not shown) may receive an input signal (IS), a horizontal synchronizing signal (Hsync), a vertical synchronizing signal (Vsync), and a main clock signal (MCLK) from outside such as the processor 150, for example, and generate image data signal, scan control signal, data control signal, light emission control signal, and the like, and provide the generated signal to the display panel 110, the data driver 161, the gate driver 162, and the like.

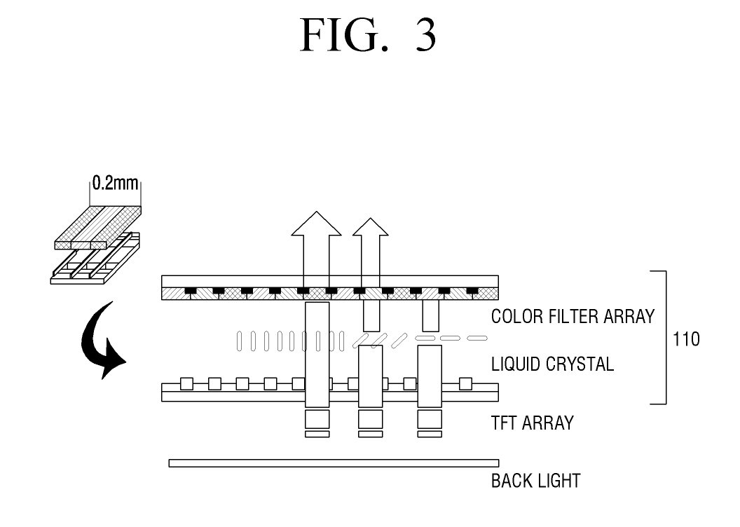

FIG. 3 is a diagram illustrating an example method of expressing pixel values of an LCD panel according to an example embodiment of the present disclosure.

Liquid crystal display (LCD) uses the electric characteristic of a liquid crystal, which is in an intermediate state between a liquid and a solid, for a display apparatus.

The liquid crystal elements in the LCD are aligned in response to an electric field, thus selectively passing a light having a certain directional wave. That is, due to characteristic of the molecular structure, liquid crystals are linearly aligned by an electric field, and due to their mechanical characteristics, the liquid crystals are capable of rotating by 90 degrees between the layers. This 90-degree rotated alignment is called twisted nematic (TN), and 270-degree rotated alignment is called super twisted nematic (STN). With an application of an electric field to the rod-shaped liquid crystal intervened by 2 layers therebetween, the position of the liquid crystal is changed according to the direction of the electric field, and the amount of transmitted light is changed. That is, the liquid crystal is twisted by the effective voltage between the sub-pixel electrode and the common electrode so that the light transmittance, that is, the pixel data value may be controlled.

Hereinafter, various example embodiments of the present disclosure will be described in more detail with reference to the drawings.

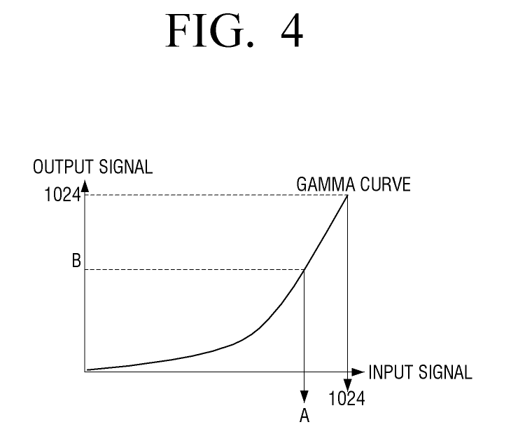

FIG. 4 is a diagram illustrating an example gamma curve according to an example embodiment of the present disclosure.

As illustrated in FIG. 4, the gamma curve represents (corresponds to) the relationship between the gray level of the input signal input to the display panel 110 and the luminance of the output signal. In this example, the gamma curve may be a gamma curve having a gamma value of 2.2 as described above with reference to FIG. 1.

The processor 150 may calculate (determine) a first output luminance value corresponding to the maximum gray level value that can be output by the display panel 110, and a second output luminance value corresponding to the maximum gray level value of the input signal, based on the gamma curve. In this example, the gamma curve may not be used for calculating the first output luminance value, although it is possible to use the gamma curve if necessary.

For example, it is assumed that the maximum gray level value that can be output by the display panel 110 is 1023, and the luminance value corresponding to the gray level value is 1023 nit.

In this case, if the maximum gray level value of the specific input frame is A, the output luminance value B corresponding to A may be identified based on the gamma curve, and a difference value (e.g., 1023−B) may be calculated based on the output luminance value 1023 corresponding to the 1023, i.e., the maximum gray level value 1023 that can be output by the display panel 110. For example, if B=512, the difference of the output luminance value is 511.

The processor 150 may control at least one of the current duty and the current intensity for driving the backlight unit 120 based on the difference of the output luminance value. For example, at least one of current duty and current intensity may be decreased by the degree corresponding to the difference of the output luminance value. Hereinafter, a detailed description will be given with reference to the drawings.

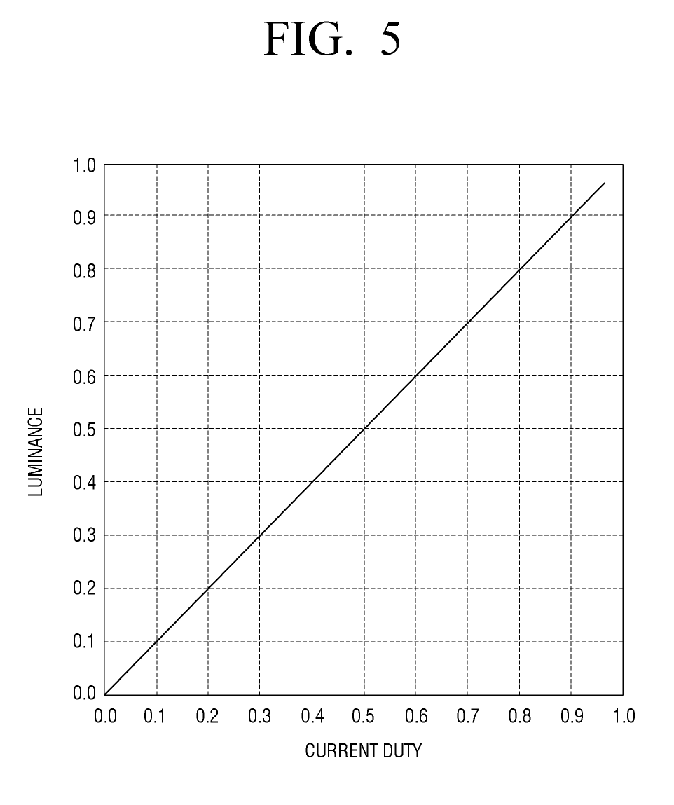

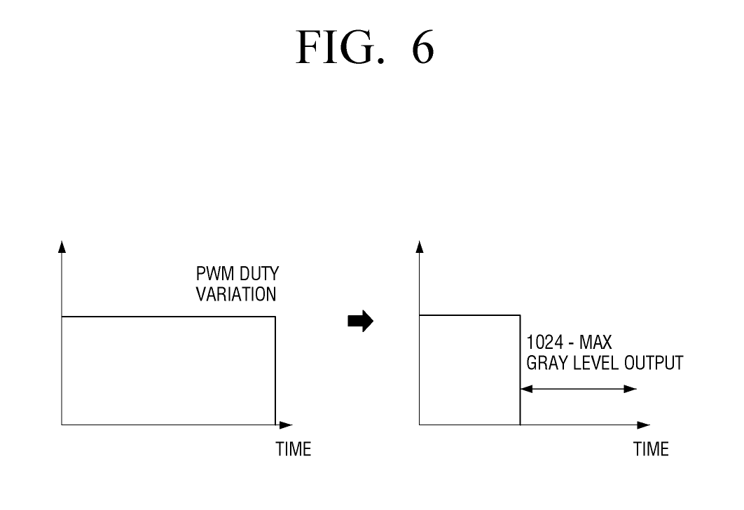

FIGS. 5 and 6 are diagrams illustrating an example PWM dimming method according to an example embodiment of the present disclosure.

FIG. 5 is a graph showing a relationship between a current duty applied to the LED backlight unit 120 and a luminance, according to an embodiment of the present disclosure.

As illustrated in FIG. 5, there is a linear relationship between the current duty applied to the LED backlight unit 120 and the luminance. That is, the luminance of the LED backlight unit 120 varies linearly in accordance with the duty of the forward current.

For example, it is assumed that the maximum gray level value of the input signal is A, and that the output luminance value corresponding to the maximum gray level value A of the input signal is ‘B=512 nit’ according to the gamma curve. Since the output luminance value corresponding to the maximum gray level value that can be output by the display panel 110 is 1023 nit, the difference between the maximum gray level value that can be output by the display panel 110 and the maximum gray level value corresponding to the maximum gray level value of the input signal is 1023−512=511 nit.

In this case, as illustrated in FIG. 6, the luminance of the backlight unit 120 may be decreased by the amount corresponding to the difference of the maximum gray level value. That is, the brightness of the backlight unit 120 may be decreased by 511/1023≈0.5(50%). In this case, as illustrated in FIG. 6, since there is a linear relationship between the current duty applied to the LED backlight unit 120 and the luminance, the current duty may be decreased by 511/1024≈0.5(50%).

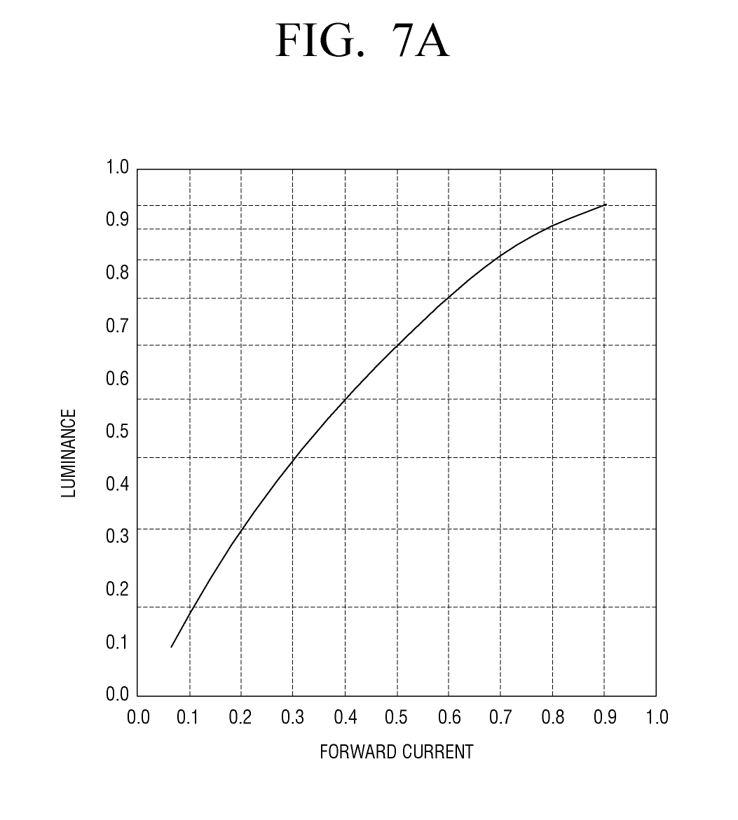

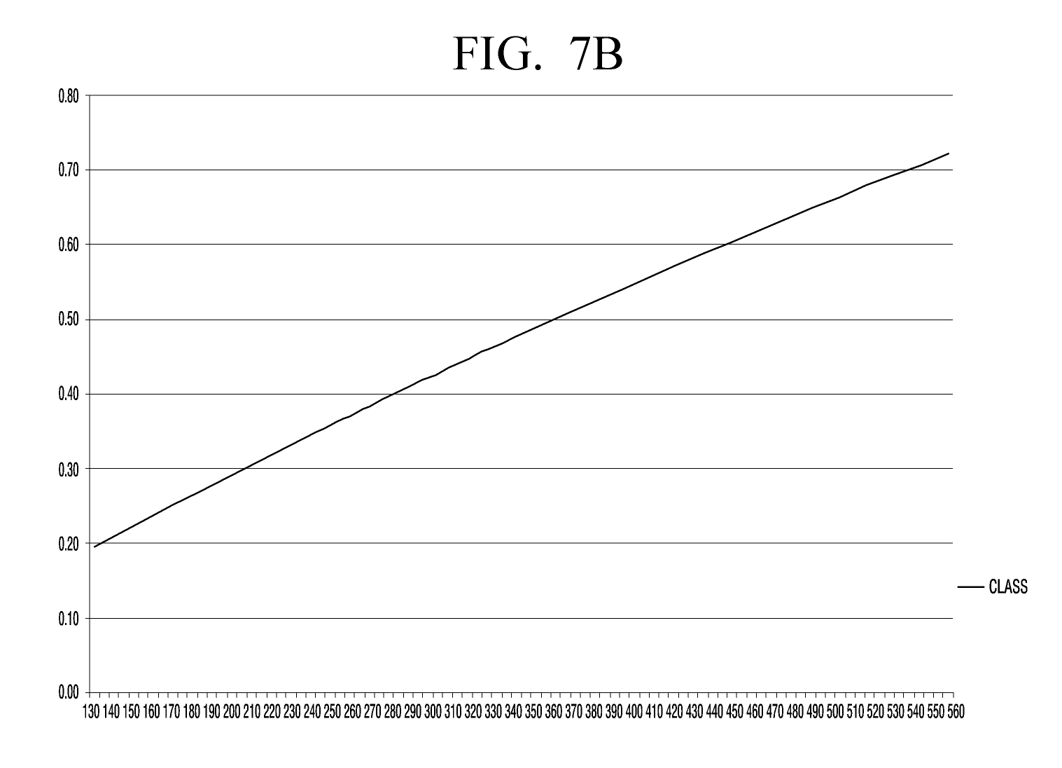

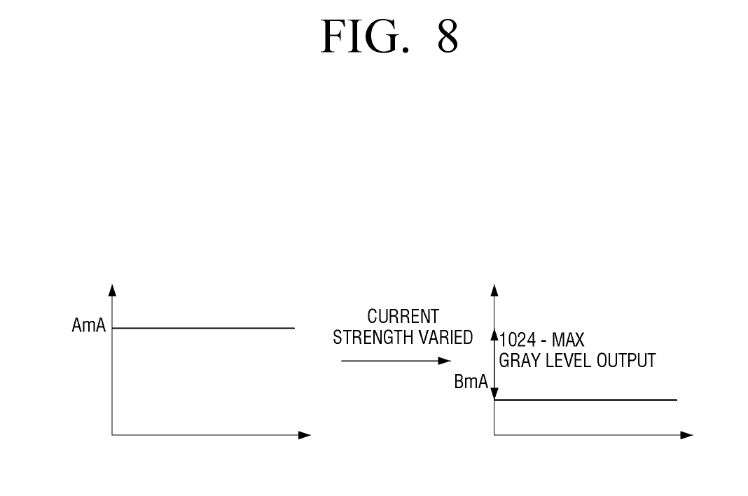

FIGS. 7A, 7B, and 8 are diagrams illustrating an analog dimming method according to an example embodiment of the present disclosure.

FIGS. 7A and 7B are graphs illustrating a relationship between a current value (or a voltage value) applied to the LED backlight unit 120 and luminance, according to an embodiment of the present disclosure.

There is a nonlinear relationship between the current value (or voltage value) applied to the LED backlight unit 120 and the luminance, as illustrated in FIG. 7A (or FIG. 7B). That is, the brightness of the LED backlight unit 120 changes non-linearly according to the forward current.

For example, it is assumed that the maximum gray level value of the input signal is A, and that the output luminance value corresponding to the maximum gray level value A of the input signal is ‘B=512 nit’ according to the gamma curve. Since the output luminance value corresponding to the maximum gray level value that can be output by the display panel 110 is 1023 nit, the difference between the maximum gray level value that can be output by the display panel 110 and the maximum gray level value corresponding to the maximum gray level value of the input signal is 1023−512=511 nit. In this case, the brightness of the backlight unit 120 may be decreased by the amount corresponding to the difference of the maximum gray level value. That is, the brightness of the backlight unit 120 may be decreased by 511/1024≈0.5(50%).

In this case, as illustrated in FIG. 7A (or FIG. 7B), since there is a nonlinear relationship between the current duty applied to the LED backlight unit 120 and the luminance, a corresponding current value (or current gain) may be calculated (determined) based on the graph of FIG. 7A (or FIG. 7B) to decrease the luminance by 50%. For example, based on FIG. 7A, if the current value at the current time is 10 mA and the current gain for decreasing the luminance by 50% is 0.4, the current may be 10 mA*0.4=4 mA. On the other hand, FIG. 7B shows the relationship between the current value applied to the LED backlight unit 120 and the luminance ratio, as obtained by experiment, such that, in one example, the luminance ratio on the right side of the graph=0.000000000047701*I3−0.000000510381229*I2+0.001545454573109*I+0.002999749439957. In other words, as illustrated in FIG. 8, the value applied to the backlight unit 120 may be decreased base on the difference between the maximum gray level value that can be output by the display panel 110 and the maximum gray level value corresponding to the maximum gray level value of the input signal.

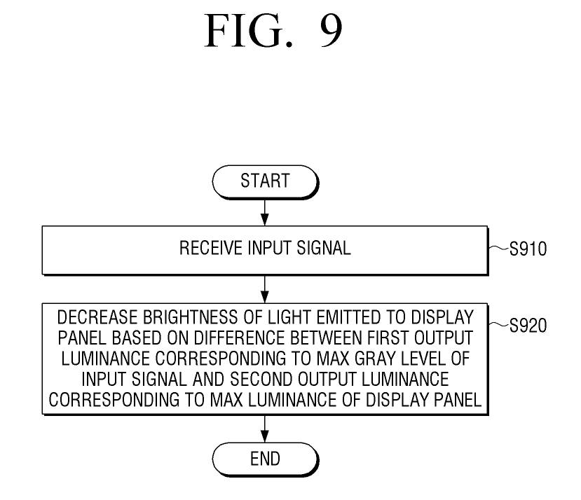

FIG. 9 is a flowchart illustrating an example method of driving a display apparatus according to an example embodiment of the present disclosure.

As illustrated in FIG. 9, a driving method of a display apparatus according to an example embodiment includes, receiving an input signal at S910, and decreasing the brightness of the light provided to the display panel based on a difference between the first output luminance value corresponding to the maximum luminance value of the display panel, and the second output luminance value of the input signal, at S920. In this example, the gamma curve may be information indicating the relationship between the gray level of the input signal input to the display panel and the luminance of the output signal. Further, the first output luminance value may be an output luminance value corresponding to the maximum gray level value that can be output by the display panel. The second output luminance value may be an output luminance value corresponding to the maximum gray level value of the input signal in the gamma curve.

Meanwhile, the display panel may be implemented as a liquid crystal panel, but not limited thereto.

The brightness of the light radiated to the display panel may then be decreased by the first output luminance value and the second output luminance value, at S920. For example, based on the maximum brightness of the backlight, the brightness of the backlight may be decreased by the first output luminance value and the second output luminance value.

Further, the operation at S920 of decreasing the brightness of the light may include decreasing the brightness of the light by the difference between the first output luminance value and the second output luminance value and driving the backlight unit with global dimming. That is, the brightness of a plurality of light sources comprising the backlight unit may be collectively decreased so as to correspond to the difference between the first output luminance value and the second output luminance value.

Further, the operation at S920 of decreasing the brightness of the light may include decreasing at least one of the current duty and the current intensity of the backlight unit based on the difference between the first output luminance value and the second output luminance value.

The operation at S920 of decreasing the brightness of the light, if at least one of the target current duty and the target current intensity of the backlight unit is determined based on the difference between the first output luminance value and the second output luminance value, at least one of the current duty and the current intensity may be decreased stepwise to at least one of the target current duty and the target current intensity.

Further, the operation at S920 of decreasing the brightness of the light may include decreasing stepwise at least one of the current duty and the current intensity of the backlight unit, upon determining at least one of the current duty variation and the current intensity variation of the backlight unit based on the difference between the first output luminance value and the second output luminance value.

The operation at step S920 of decreasing the brightness of the light may include calculating (determining) a first output luminance value corresponding to the maximum gray level value in units of at least one frame of the input signal, and decreasing the brightness of the light provided to the display panel in units of at least one frame.

Further, the driving method may further include compensating for the luminance drop due to decreased brightness of the backlight unit, with a gray level value of the input signal. In this case, the gain value for compensating for the luminance drop is calculated based on the maximum gray level value of the input signal, and a compensated gray level value may be calculated by applying the gain value to the gray level value of the input signal.

As described above, according to various example embodiments of the present disclosure, the global dimming of the backlight may be controlled while maintaining the gamma curve, so that the gray level of the input signal may be accurately expressed. Further, the black signal may be improved so that the contrast ratio may be improved.

Meanwhile, the methods according to various example embodiments of the present disclosure described above may be implemented with software/hardware upgrade for existing display apparatuses.

Further, a non-transitory computer readable medium may be provided, in which a program for sequentially performing the driving method according to the present disclosure is stored.

Meanwhile, the driving method according to various example embodiments of the present disclosure described above may be implemented as computer-executable program code and may be provided in a state of being stored on various non-transitory computer readable media.

The non-transitory computer readable medium is a medium capable of storing data and being readable by a device. In particular, the various applications or programs described above may be stored and provided on a non-transitory computer readable medium such as CD, DVD, hard disk, Blu-ray disk, USB, memory card, ROM, and so on.

The foregoing example embodiments and advantages are merely examples and are not to be construed as limiting the example embodiments. The present teaching can be readily applied to other types of apparatuses. Also, the description of the example embodiments of the present disclosure is intended to be illustrative, and not to limit the scope of the claims.

What is claimed is:

1. A display apparatus, comprising:
a display panel;
a backlight unit comprising a light source configured to provide a light to the display panel;
a storage configured to store a gamma curve corresponding to a relationship between a gray level of an input signal and a luminance of an output signal; and
a processor configured to:
control the backlight unit to decrease a brightness of the light provided to the display panel based on a difference between a first output luminance value which is a maximum luminance value of the display panel and a second output luminance value of the input signal,
wherein the second output luminance value is an output luminance value corresponding to a maximum gray level value of the input signal in the gamma curve.

2. The display apparatus according to claim 1, wherein the first luminance value is an output luminance value corresponding to a maximum gray level value that can be output by the display panel.

3. The display apparatus according to claim 1, wherein the processor is configured to decrease the brightness of a plurality of light sources comprising the backlight unit based on the difference between the first output luminance value and the second output luminance value.

4. The display apparatus according to claim 3, wherein the processor is configured to decrease at least one of current duty and a current intensity of the backlight unit based on the difference between the first output luminance value and the second output luminance value.

5. The display apparatus according to claim 4, wherein, the processor is configured to stepwise decrease at least one of the current duty and the current intensity of the backlight unit to at least one of the target current duty and the target current intensity if at least one of the target current duty and the target current intensity of the backlight unit is determined based on the difference between the first output luminance value and the second output luminance value.

6. The display apparatus according to claim 4, wherein, the processor is configured to stepwise decrease at least one of the current duty and the current intensity of the backlight unit if at least one of a current duty variation and a current intensity variation of the backlight unit is determined based on the difference between the first output luminance value and the second output luminance value.

7. The display apparatus according to claim 1, wherein the processor is configured to determine the first output luminance value corresponding to a maximum gray level value in units of at least one frame of the input signal and to decrease the brightness of the light provided to the display panel in units of at least one frame.

8. The display apparatus according to claim 1, wherein the processor is configured to compensate for a luminance drop due to a decrease in the brightness of the backlight unit, with a gray level value of the input signal.

9. The display apparatus according to claim 8, wherein the processor is configured to determine a gain value for compensating for the luminance drop based on the maximum gray level value of the input signal and to apply the gain value to the gray level value of the input signal to determine a compensated gray level value.

10. The display apparatus according to claim 1, wherein the display panel comprises a liquid crystal panel.

11. A method of driving a display apparatus in which a gamma curve corresponding to a relationship between a gray level of an input signal and a luminance of an output signal is stored, the method comprising:
receiving an input signal; and
decreasing a brightness of light provided to the display panel based on a difference between a first output luminance value which is a maximum luminance value of the display panel and a second output luminance value of the input signal,
wherein the second output luminance value is an output luminance value corresponding to the maximum gray level value of the input signal in the gamma curve.

12. The method according to claim 11, wherein the first luminance value is an output luminance value corresponding to the maximum gray level value that can be output by the display panel.

13. The method according to claim 11, wherein the decreasing the brightness of the light comprises decreasing the brightness of a plurality of light sources comprising the backlight unit that provides a light to the display panel, based on a difference between the first output luminance value and the second output luminance value.

14. The method according to claim 13, wherein the decreasing the brightness of the light comprises decreasing at least one of a current duty and a current intensity of the backlight unit based on the difference between the first output luminance value and the second output luminance value.

15. The method according to claim 14, wherein the decreasing the brightness of the light comprises, stepwise decreasing at least one of the current duty and the current intensity of the backlight unit to at least one of the target current duty and the target current intensity if at least one of the target current duty and the target current intensity of the backlight unit is determined based on the difference between the first output luminance value and the second output luminance value.

16. The method according to claim 14, wherein the decreasing the brightness of the light comprises, stepwise decreasing at least one of the current duty and the current intensity of the backlight unit if at least one of a current duty variation and a current intensity variation of the backlight unit is determined based on the difference between the first output luminance value and the second output luminance value.

17. The method according to claim 11, wherein the decreasing the brightness of the light comprises determining the first output luminance value corresponding to a maximum gray level value in units of at least one frame of the input signal and decreasing the brightness of the light provided to the display panel in units of at least one frame.

18. The method according to claim 11, further comprising compensating for luminance drop due to a decrease in the brightness of the backlight unit, with a gray level value of the input signal.

19. The method according to claim 18, wherein the compensating comprises determining a gain value for compensating for the luminance drop based on the maximum gray level value of the input signal and applying the gain value to the gray level value of the input signal to determine a compensated gray level value.

20. The method according to claim 11, wherein the display panel comprises a liquid crystal panel.
